(19) United States
(12) Patent Application Publication
(10) Pub. No.: US 2014/0206270 A1
(43) Pub. Date: Jul. 24, 2014

(54) SLAT, METHOD FOR MOUNTING A SLAT, INJECTION MOLD AND METHOD FOR MANUFACTURING A COMPONENT OF A SLAT

(71) Applicant: TRW Automotive Electronics & Components GmbH, Radolfzell (DE)

(72) Inventors: Michael Demerath, Hueffler (DE); Dirk Lauhoff, Kaiserslautern (DE)

(73) Assignee: TRW Automotive Electronics & Components GmbH, Radolfzell (DE)

(21) Appl. No.: 14/104,009

(22) Filed: Dec. 12, 2013

(30) Foreign Application Priority Data
Jan. 18, 2013 (DE) 10 2013 100 528.4

(51) Int. Cl. B60H 1/34; B21D 53/88; B29C 45/00

(52) U.S. Cl. CPC B60H 1/3414; B29C 45/0017; B21D 53/88
USPC 454/155; 264/279; 425/129.1; 29/897.2

(57) ABSTRACT

In a slat, in particular for an air vent in a vehicle, with a base body and an add-on part which are mounted at each other by means of a mechanical connection, the mechanical connection contains at least one holding element at one of the two components base body and add-on part and at least one receptacle for the holding element at the other one of the two components, wherein the receptacle includes at least one insertion portion, into which the holding element can be inserted in an insertion direction, and at least one succeeding holding portion, in which the holding element can be fixed.

### TECHNICAL FIELD

The invention relates to a slat, in particular for an air vent in a vehicle. The invention furthermore relates to an injection mold for injection molding and to a method for manufacturing a component for a slat.

### BACKGROUND OF THE INVENTION

Slats for air vents can comprise a base body and an add-on part, which are mounted at each other by means of a mechanical connection, and to a method for mounting such slat.

To give air vents in vehicles a high-quality appearance, the front edges of the slats of the air vent frequently are provided with a coating, for example a chromium plating. A partial coating of one-part slats, however, involves a very high manufacturing expenditure.

For this reason, slats for air vents in vehicles frequently are composed of two components. A first component forms the base body of the slat which represents the rear part of the slat, most of which is not visible, and can be made of an inexpensive material. At this base body an add-on part is mounted as second component, which forms the front, visible part of the slat. This attachment part for example can have a chromium plating or some other surface coating, which is suitable to give the slat a high-quality appearance.

The two-part structure has the advantage that only the attachment part with a very much smaller surface and not the entire slat must be coated. The attachment part can be coated completely because of the smaller surface, so that an additional expenditure of labor due to a partial coating of the component is not required.

From the prior art, two-part slats are known, in which the attachment part is attached to the base body with a clip connection. This offers a fast and simple possibility for attaching the components of the slat to each other. Such clip connections may be separated, however, under extreme loads. In addition, a replacement of the attachment part, for example to change the appearance of the slat or the air vent, is very expensive. It is the object of the invention to provide a slat for an air vent which ensures a secure hold of the attachment part and provides for an easy assembly and disassembly of the attachment part. The object of the invention furthermore is to provide a method for mounting such slat. Furthermore, it is the object of the invention to provide an injection mold for injection molding a component of such slat and a method for manufacturing this component.

### BRIEF DESCRIPTION OF THE INVENTION

For the solution of the object there is provided a slat, in particular for an air vent in a vehicle, with a base body and an add-on part. The base body and the add-on part are mounted at each other by means of a mechanical connection. The mechanical connection contains at least one holding element at one of the two components base body and add-on part and at least one receptacle for the holding element at the other one of the two components. The receptacle includes at least one insertion portion into which the holding element can be inserted in an insertion direction, and at least one succeeding holding portion in which the holding element can be fixed. The component at which the holding element is provided is put against the second component with the holding element such that the holding element protrudes into the insertion portion of the receptacle of the second component. Subsequently, the first component is shifted relative to the second component, so that the holding element is pushed into the holding portion, from which the holding element no longer can be withdrawn, whereby the components are securely fixed at each other. A replacement of the first component or the second component is possible by again shifting the holding element into the insertion portion, from which it can be withdrawn. The holding portion for example can be narrowed with respect to the insertion portion such that the holding element is jammed or wedged in the holding portion.

The holding element also can include at least one protruding holding part and at the holding portion an undercut is provided, behind which the holding part can engage. The undercut preferably is formed such that the holding part engages behind the same against the insertion direction and the holding part or holding element is securely fixed in the receptacle against the insertion direction and cannot be withdrawn.

The holding element and the receptacle works according to the principle of a bayonet lock so to speak, so that reversible mounting of the two components is possible and an easily separable, but very stable connection between base body and add-on part can be established.

Preferably, the holding portion is arranged laterally beside the insertion portion. Mounting the base body and the add-on part for example can be effected such that the same are put against each other with corresponding contact surfaces and subsequently the component with the holding element is laterally shifted, with the contact surfaces serving as sliding surfaces, so to speak. Since shifting only is effected laterally, the distance of the components to each other is not changed during the mounting operation, so that the components can be manufactured such that in the mounted condition the slat has not gaps or slots between the components.

The holding element for example can be a protruding rib extending in longitudinal direction of the component, at which several, in particular uniformly distributed holding parts are provided. The receptacle for example can be a groove extending in longitudinal direction, which includes several, in particular uniformly distributed insertion portions and holding portions, wherein the distance of the insertion portions corresponds to the distance of the holding parts. The protruding rib with the holding parts provided thereon is positioned such that the holding parts each can be inserted into the insertion portions. Subsequently, the holding element is shifted in longitudinal direction of the rib or component such that the holding parts engage behind the undercuts of the holding portions. The rib or the groove preferably extends approximately along the entire length of the component, so that along the entire length of the component a positive connection is made between base body and add-on part, and the add-on part is very securely held at the base body. The groove for example forms a continuous opening for all insertion portions and holding portions.

The holding parts can be protrude from the holding element laterally and/or in an insertion direction. Thus, the same can protrude from the holding element in dependence on the groove or the latching direction in which the holding element is shifted from the insertion portion into the holding portion. The holding parts for example can be hook-shaped. It is, however, also conceivable that the same form a head, which has a larger cross-section, which can engage behind the undercuts of the holding portions.

It is also possible for example that adjacent holding parts protrude from the holding element to different sides.

To be able to insert the holding parts more easily into the insertion portions of the receptacle, the same can include an insertion bevel, for example. Furthermore, it is conceivable that the holding parts include latching tabs which are able to yield resiliently on insertion into the receptacle.

The insertion portion as well as the holding portion preferably include a substantially rectangular opening. The holding part likewise can have a substantially rectangular cross-section corresponding in particular to the insertion portion, so that the same can easily be inserted into the insertion portion.

To be able to insert the holding element into the receptacle, the width of the insertion portion preferably is larger than or equal to the width of the holding part.

In the mounted condition of the slat or in the installed condition in an air vent, a release of the mechanical connection should not be possible or only against a major resistance, in order to prevent an inadvertent release of the mechanical connection. For example, this can be effected in that the installation space in the air vent is limited against the latching direction, so that the components cannot be shifted against each other to such an extent that the holding element gets into the insertion portion. Alternatively, it is possible that at the holding element a latching element is provided, which can snap into place in the receptacle, in particular in the holding portion, so that an increased resistance is provided, in order to shift the holding part or the holding element back into the insertion portion.

The base body and/or the add-on part preferably are made of plastics, in particular by injection molding, wherein the add-on part has a surface coating, in particular a chromium plating.

For the solution of the above mentioned object, a method for mounting a slat according to the invention furthermore is provided, wherein the holding element is introduced into the insertion portion in an insertion direction and subsequently shifted in a latching direction substantially vertical thereto, so that the holding element gets into the holding portion in which the holding element is fixed. This provides for an easy assembly of the add-on part at the base body, wherein by moving against the latching direction a disassembly of the slat also is possible without damaging the components.

The latching direction extends substantially in longitudinal direction of the base body and/or the add-on part. This offers the advantage that shifting of the holding elements against the latching direction can be prevented with simple means. In the installed condition of the slat in an air vent, the slat rests against the housing of the air vent on both sides in longitudinal direction and has only little clearance to the side walls of the air vent. This clearance is so small that the add-on part no longer can be shifted to such an extent that the holding elements get into the insertion portion.

In accordance with the invention, an injection mold furthermore is provided for injection molding a component of a slat according to the invention, which includes a receptacle, with at least one molded part and a slide, wherein the slide is shiftable between an injection position, in which the slide together with the molded part keeps the receptacle clear, and a demolding position. The molded part has the shape of a holding element and at least keeps the holding regions clear. The slide is formed such that the same keeps the insertion regions clear alone or in combination with the molded part, wherein the slide is movable from the injection position into the demolding position against the insertion direction, substantially vertically to the longitudinal direction of the component, in particular away from the component.

With such an injection mold, an easy manufacture of the component of the slat, which includes a receptacle, with insertion portions and holding portions is possible in one injection operation, even if the holding portions have undercuts. The molded part substantially has the shape of the holding element of the second component of the slat according to the invention, so that the regions of the receptacle, which the holding element occupies in the holding position, are kept clear by the molded part. The molded part thus is arranged in the injection mold such that it defines the holding element in the holding position. In addition, the slides keep clear the insertion portions alone or in combination with the molded part. The molded part together with the slide thus keeps clear the entire receptacle.

After injection molding the component, the slide is removed against the insertion direction, so that the insertion portions are cleared wholly or in part. The molded part thus can be moved from the holding portions into the insertion portions analogous to a holding element. Subsequently, the component or the molded part is shifted such that the molded part gets into the insertion portions and the component thus can be separated from the molded part, in that the molded part is removed through the insertion portions.

The molded part also can be formed as second slide and be movable between an injection position, in which the molded part keeps clear the holding portions, and a demolding position in which the molded part engages into the insertion portions.

The molded part preferably has a constant cross-section which corresponds to the shape of the holding element and/or the cross-section of the holding part, i.e. forms the holding element.

In accordance with the invention, there is furthermore provided a method for manufacturing a component for a slat according to the invention, which includes a receptacle, with an injection mold according to the invention, wherein the method includes the following steps:
the slide is shifted into the injection position in which the slide along with the molded part keeps clear the receptacle,
the injection mold is filled with plastic,
after curing of the plastic, the slide is shifted in a first demolding step into the demolding position in which the holding regions are cleared,
subsequently, the molded part or the component is shifted in longitudinal direction such that the molded part engages into the insertion portions and the molded part is removed from the receptacle against the insertion direction.

### BRIEF DESCRIPTION OF THE DRAWINGS

Further advantages and features can be taken from the following description in conjunction with the attached drawings, in which:

FIG. 1 shows a slat according to the invention,

FIG. 2 shows a schematic sectional view through an air vent with a plurality of slats according to the invention,

FIGS. 3a to 3c show various views of the add-on part of the slat of FIG. 1,

FIGS. 4a to 4c show various views of the base body of the slat of FIG. 1,

FIGS. 5a to 5c show various steps of a method for mounting the slat of FIG. 1,

FIGS. 6a to 6c show various views of an alternative embodiment of the add-on part of the slat of FIG. 1,

FIGS. 7a to 7c show a schematic representation as well as sectional views of an injection mold for injection molding a component of the slat of FIG. 1,

FIGS. 8a and 8b show various positions of a molded part and of a slide of the injection mold of FIG. 7, and

FIGS. 9a to 9c show various steps of the manufacturing method of a slat of FIG. 1 with an injection mold according to FIG. 7.

### DETAILED DESCRIPTION OF THE INVENTION

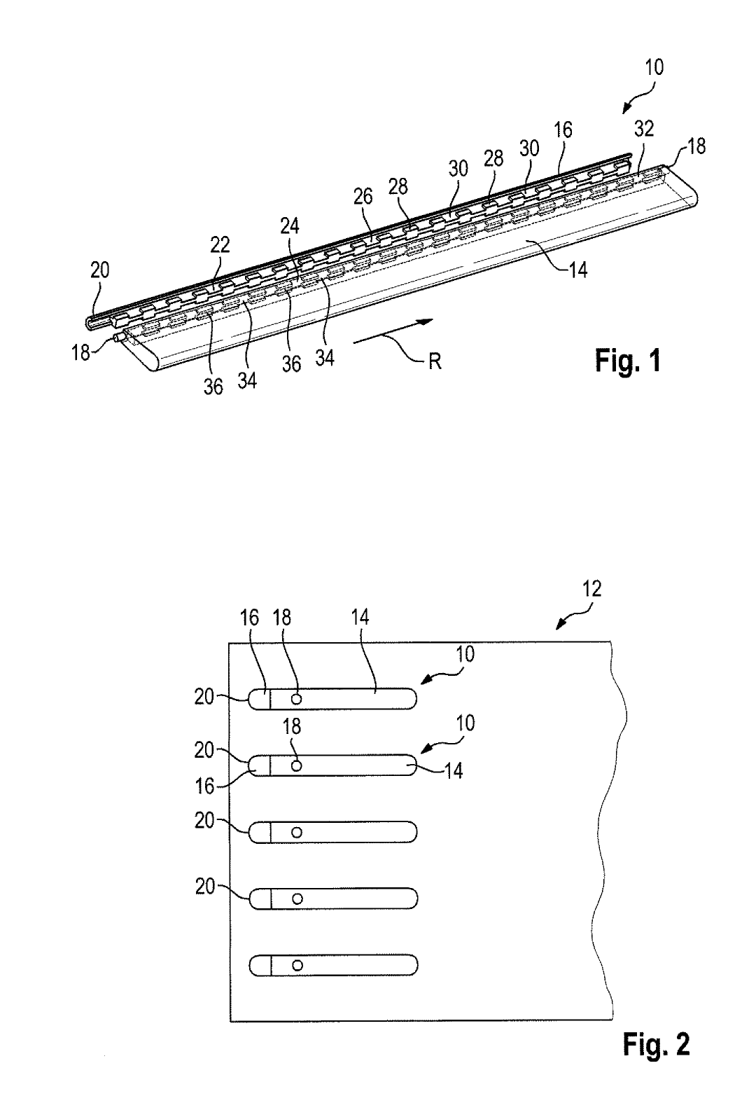

FIG. 1 shows a slat 10 for an air vent 12 schematically shown in FIG. 2. The slat 10 has a base body 14 and an add-on part 16 which can be attached to the base body 14 by means of a mechanical connection. At the base body 14 bearings 18 are provided, which are formed by bolts protruding in longitudinal direction R. With these bearings 18, the slat 10 can pivotally be mounted in an air vent 12.

As shown in FIG. 2, the add-on part 16 is mounted at the front edge of the base body 14, so that the same forms the front edge 20 of the slat 10. In the installed condition, this front edge 20 of the slat 10 substantially can be seen, i.e. merely the add-on part.

In such air vents 12 for vehicles a high-quality appearance is desired, which is achieved for example by a coating, in particular a chromium plating of the front edge 20 of the slat 10. A complete coating of a one-part slat, however, is not desirable for cost reasons, as in such method also those parts of the slat 10 would be coated which are not visible. A partial coating of a one-part slat, however, would involve an increased manufacturing expenditure.

For this reason, the front edge 20 of such slat is formed by a second, separate component, i.e. the add-on part 16. The same can be coated separately, with the material expenditure for coating being reduced due to the smaller surface of the component. Both components are manufactured separately and subsequently attached to each other with a mechanical connection.

The mechanical connection of the two components is formed by a holding element 22 provided at the add-on part 16 and by a receptacle 24 provided at the base body 14. The holding element 22 can be inserted into the receptacle 24 and, as will be explained below, be fixed in the same.

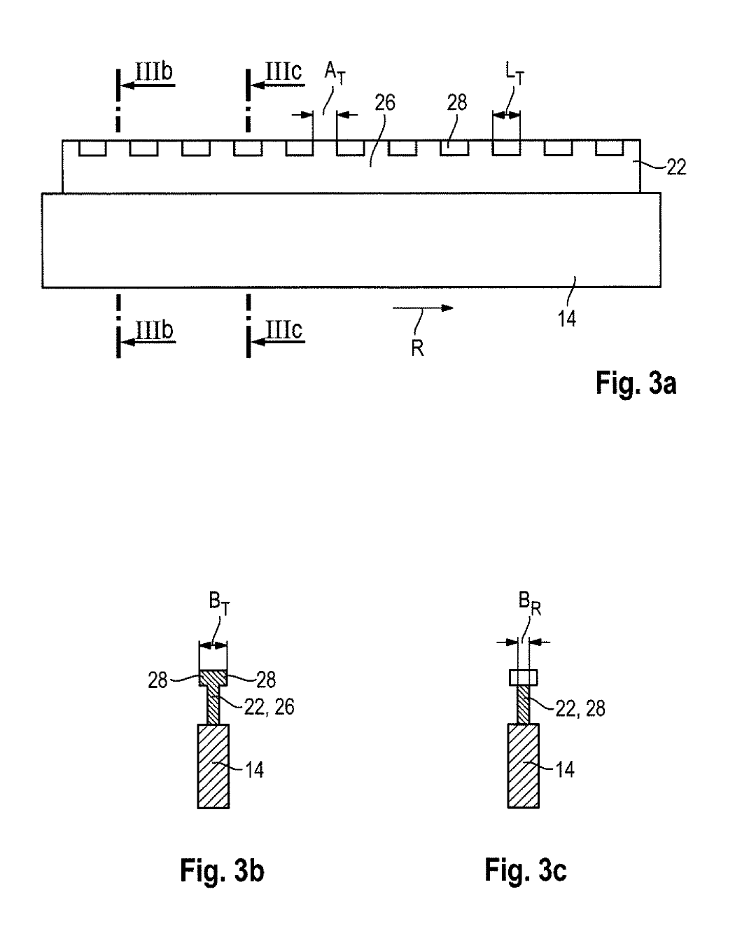

As shown in FIGS. 3a to 3c, the holding element includes a protruding rib 26 extending in longitudinal direction R with a width B_{R}, from which holding parts 28 protrude at regular intervals. In the embodiment shown here, the same are formed by rectangular protrusions which protrude from the rib 26 on both sides and have a width B_{T}. Between the holding parts 28, cutouts 30 each are formed (FIG. 3c).

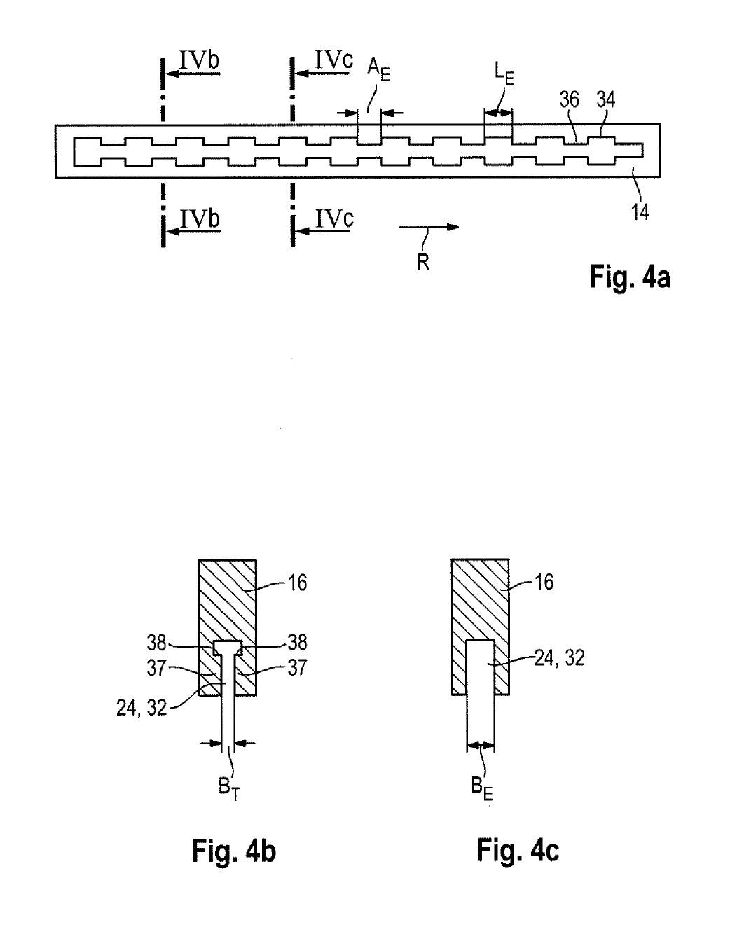

The receptacle 24 has a groove 32 extending in longitudinal direction R, which includes a plurality of insertion portions 34 and holding portions 36. In longitudinal direction R, insertion portions 34 and holding portions 36 each alternate (FIG. 4a).

The length L_{E} of the insertion portions 34 corresponds to the length L_{T} of the holding parts 28 or is slightly larger than the same. The width B_{E} of the insertion portions 34 likewise is equal to or slightly larger than the width B_{T} of the holding parts (FIG. 3b). The distance A_{E} of the insertion portions 34 corresponds to the distance A_{T} of the holding parts 28.

In the region of the holding portions 36, protrusions 37 are provided in the groove, by which the undercuts 38 are formed. The distance of the protrusions 37 or the width B_{H} of the groove 32 in the holding portions is smaller than the width B_{T} of the holding parts 28, but slightly larger than the width B_{R} of the rib 26 or of the holding element 22.

This means that a holding element 28, when it is located in the holding portion 36, cannot be withdrawn from a holding portion 36 against an insertion direction E due to the larger width B_{T}. On the other hand, a holding part 28 can be inserted into the insertion portions 34 in insertion direction E or be withdrawn from the same against the insertion direction E.

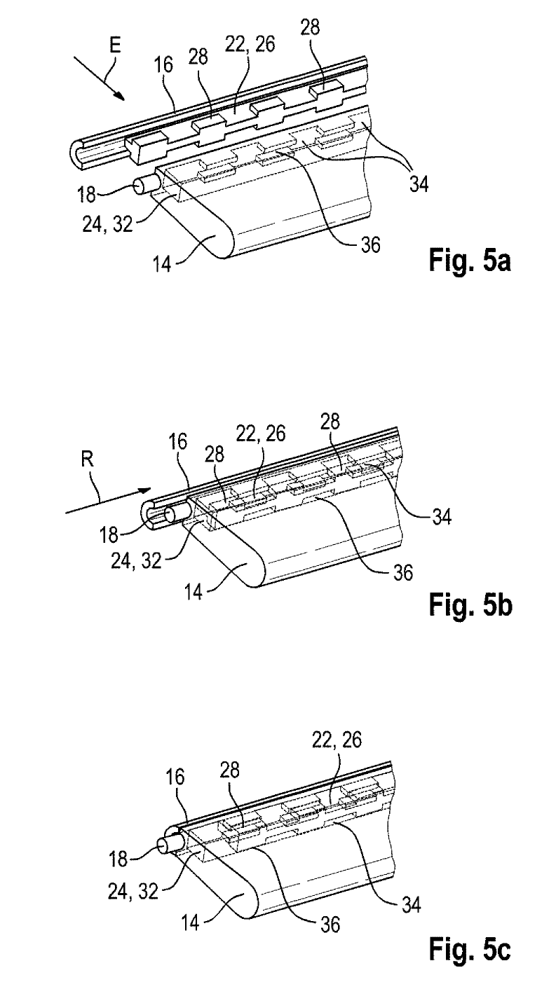

The add-on part 16 and the base body 14 have corresponding contact surfaces 40, 42 which extend in longitudinal direction R. For mounting the add-on part 16 at the base body 14, the add-on part 16 with the holding element 22 is attached to the base body 14 in an insertion direction E, wherein the holding element 22 with the holding parts 28 is inserted into the insertion portions 34 of the groove 32 or the receptacle 24 (FIG. 5a).

When the add-on part 16 and the base body 14 lie flat on each other with the contact surfaces 40, 42, the add-on part 16 is shifted in a latching direction, which in this embodiment corresponds to the longitudinal direction R, with the holding parts 28 or the holding element 22 being shifted such that the holding element 22 with the holding parts 28 gets out of the insertion portions 34 into the laterally succeeding holding portions 36 (FIG. 5b).

In this position, the holding parts 28 are located behind the undercuts 38, so that the add-on part 16 cannot be withdrawn from the receptacle 24 against the insertion direction E (FIG. 5c). The add-on part 16 thus is securely attached to the base body 14.

The mechanical connection works according to the principle of a bayonet connection, in that a holding element 22 is inserted into a receptacle 24 which includes an undercut 38 behind which the holding element 22 can be fixed. In contrast to a bayonet lock, however, fixing is not effected by a rotary movement, but by linearly shifting the holding element 22 in the receptacle.

In the installed condition of the slat 10 in the air vent 12, shifting of the add-on part 16 against the latching direction R is not possible, since the side walls of the air vent 12 prevent such shifting.

In addition, a latching element can be provided at the holding element 22, which can snap into place in the receptacle 24, in particular in one of the holding portions 36. Such latching element also can be provided at the holding parts 28.

In the embodiment shown, the insertion portions 34 or the holding portions 36 are formed rectangular or have a rectangular opening. The holding parts 28 likewise have a substantially rectangular cross-section corresponding in particular to the insertion portion 34, so that the same can easily be inserted into the insertion portions 34.

The shape of the insertion portions 34 or the holding portions 36, however, can be adapted as desired. The holding parts 28 likewise can have any other shape, in order to be able to engage into the holding portions 36. It must merely be ensured that the insertion portions 34 and the holding portions 36 are dimensioned such that the holding element 22 or the holding parts 28 can be pushed into the insertion portions 34 and be fixed in the holding portions 36.

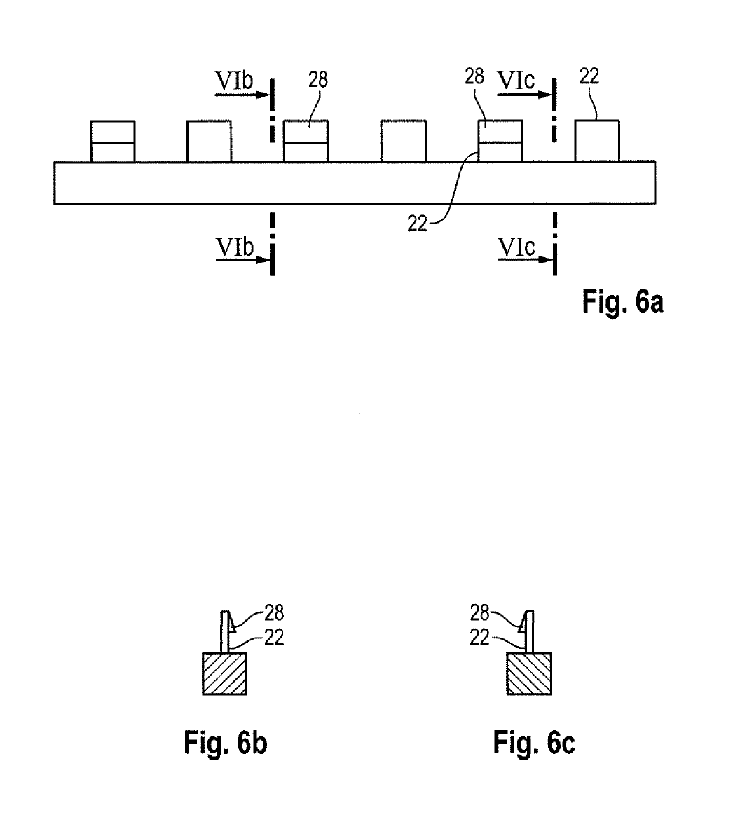

A second embodiment of a holding element 22 according to the invention is shown in FIGS. 6a to 6c. In this embodiment, a plurality of holding elements 22 located one behind the other in longitudinal direction L are provided, at which only one holding part 28 each is provided,

As can be seen in FIGS. 6a and 6c, the holding parts 28 alternately protrude from the respective holding element 22 to different sides. In addition, the holding parts 28 each include an insertion bevel 43 which facilitates the insertion of the holding elements 22 or the holding parts 28 into the receptacles 24.

The receptacle 24 corresponding to this holding element 22 substantially can be formed like the receptacle 24 shown in FIGS. 4a to 4c. Alternatively, the width of the insertion portions 34 also can each be smaller, since the holding parts 28 or the holding elements have a smaller width.

The holding parts 28, however, also can protrude from the holding elements 22 to one side only.

Instead of the continuous receptacle 24 shown in FIG. 1 it is also conceivable that for each holding element 22 a separate receptacle 24 is provided with one insertion portion 34 and one holding portion 36 each.

The holding parts 28 can protrude from the holding elements 22 in any way. It is also conceivable, for example, that the holding parts 28 laterally protrude from the holding elements 22 in latching direction or in longitudinal direction R and form hooks, so to speak, which engage into the holding portions 36 in longitudinal direction R.

In the embodiments shown here the holding element 22 each is provided at the add-on part 16. It is, however, also possible that the holding element 22 is provided at the base body 14 and the receptacle 24 is provided at the add-on part 16.

The component at which the holding element 22 is provided can easily be manufactured with an injection mold without slide, since with a suitable position of the mold parting plane the same has no undercuts.

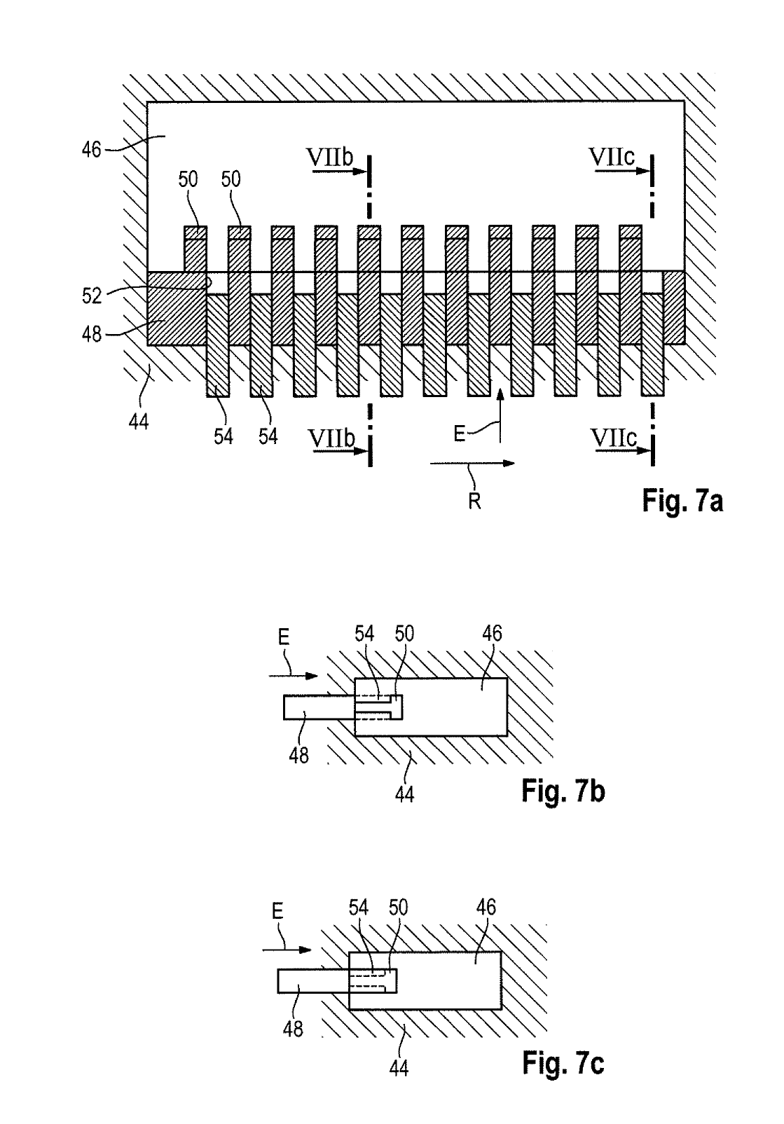

An injection mold for manufacturing a component of the slat 10, at which the receptacle 24 is provided, i.e. the base body in most cases, is shown in FIGS. 7a to 7c.

The injection mold 44 defines a cavity 46 into which liquid plastic can be filled and which forms the corresponding component. The injection mold 44 has a molded part 48 which includes a plurality of webs 50 protruding into the cavity 46, which, as shown in FIG. 7b, have the same cross-section as the holding element 72 in the region of the holding parts 28.

Between the webs 50 guideways 52 are provided at the molded part 48, in which slides 54 are shiftably mounted in insertion direction E. The slides 54 have a constant cross-section along the entire length (FIG. 7c). The width B_{S} of the slides 54 corresponds to the length L_{E} of the insertion portions 34. The height H of the slides 54 continuously corresponds to the width B_{E} of the insertion portions 34 or substantially to the width B_{T} of the holding parts 28.

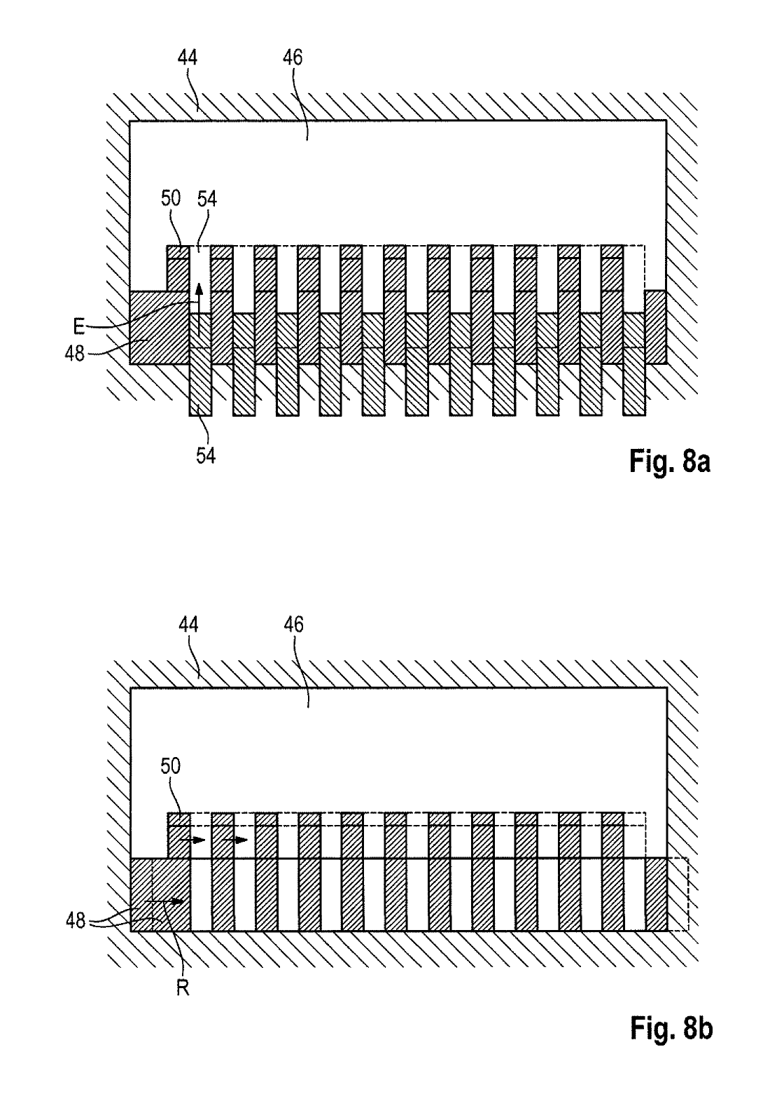

As can be seen in FIG. 8a, the slides 54 are shiftable between a demolding position and an injection position (broken lines). In the injection position, the slides 54 protrude into the cavity 46 and at the front edge 56 terminate flush with the webs 50 of the molded part 48.

The molded part 48 likewise is shiftable in longitudinal direction R between an injection position and a demolding position (FIG. 8b) and thus forms a second slide.

For injection molding the component, the molded part 48 and the slides 54 are moved into the injection position. In the injection position, the webs 50 of the molded part 48 are located at those positions in the injection mold 44 at which the holding portions 36 are provided in the finished component. Since the webs 50 have the shape of the holding portions 36, the holding portions 36 thus are kept clear completely by the webs 50 of the molded part 48.

The slides 54 have the shape of the insertion portions 34 located between the holding portions 36 and keep the same clear in the injection position.

In combination with the molded part 48, the slides 54 thus keep the entire receptacle 24 clear during the injection molding operation.

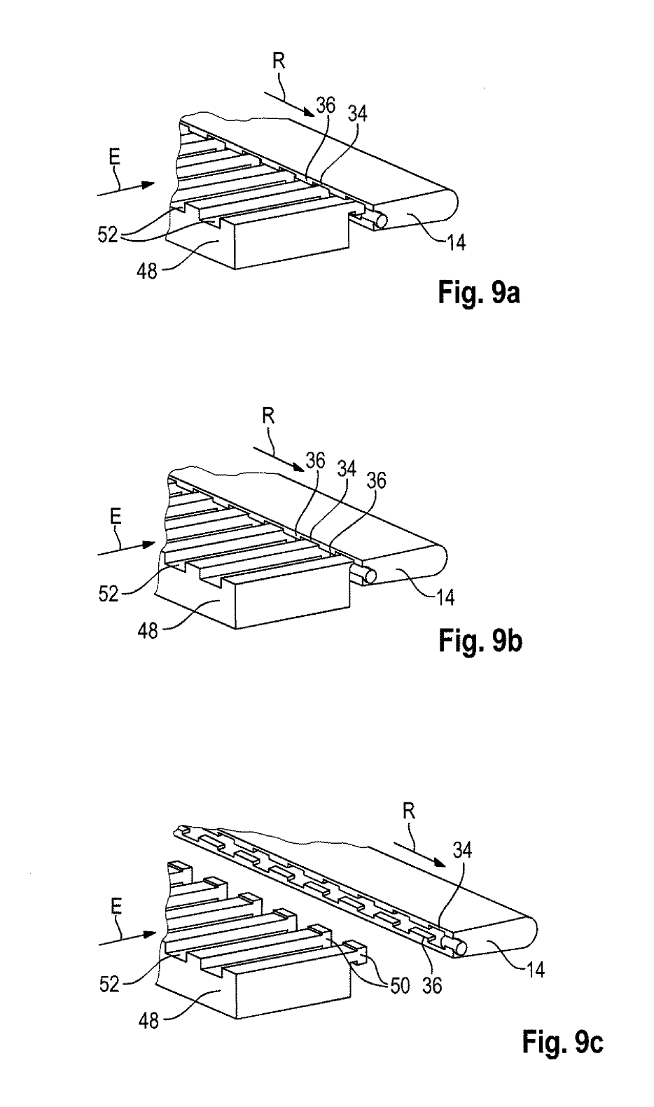

After injection molding and curing of the plastic, the slides 54 can be moved against the insertion direction E, which extends substantially vertically to the longitudinal direction of the component, i.e. away from the component, from the injection position into the demolding position. In this demolding position of the slides 54, the same no longer protrude into the component or the receptacle 24, so that the insertion portions 34 of the component are cleared (FIG. 9a).

Subsequently, the molded part 48 can be shifted in longitudinal direction R, so that the webs 50 of the molded part 48 come out of the holding portions 36 into the cleared insertion portions 34 (FIG. 9b).

Thereafter, the webs 50 and the molded part 48 can be moved out of the receptacle 24 in insertion direction E, wherein either the molded part 48 can be moved against the insertion direction E or the component can be removed in insertion direction E.

In combination with the slides 54, the entire receptacle 24 including the undercuts 38 thus is formed by the molded part 48, wherein due to the slides and the shiftable molded part 48 an easy manufacture of the component or the receptacle 24 and an easy removal of the component is possible.

In the embodiment of the injection mold as shown here, the insertion regions are completely kept clear by the slides 54. It is, however, also conceivable that the molded part 48 includes a rail connecting the webs 50 in longitudinal direction L, i.e. substantially has the shape of a holding element 22 with a continuous rib 26. In such an embodiment, the slides 54 merely keep clear those portions of the insertion portion 34 which are not kept clear by the molded part 48.

It must merely be ensured that after curing of the plastic and withdrawal of the slides 54, the molded part 48 and the finished component can be moved in longitudinal direction R such that the molded part 48 can be removed through the insertion portions 34 of the finished component.

In the illustrated embodiment, the molded part 48 is formed as second slide which is shiftable in longitudinal direction R. It is, however, also possible that the molded part 48 is formed stationary and during the demolding operation the component is moved relative to the molded part 48.

1. A slat, in particular for an air vent in a vehicle, with a base body and an add-on part which are mounted at each other by means of a mechanical connection, wherein the mechanical connection contains at least one holding element at one of the two components base body and add-on part and at least one receptacle for the holding element at the other one of the two components, wherein the receptacle includes at least one insertion portion into which the holding element can be inserted in an insertion direction, and at least one succeeding holding portion in which the holding element can be fixed.

2. The slat of claim 1 wherein the holding element includes at least one protruding holding part and at the holding portion at least one undercut is provided, behind which the holding part can engage.

3. The slat according to claim 1 wherein the holding portion is arranged laterally beside the insertion portion.

4. The slat according to claim 3 wherein the holding element is a protruding rib extending in longitudinal direction of the component, at which several, in particular uniformly distributed holding parts are provided, and the receptacle is a groove extending in longitudinal direction, which includes several, in particular uniformly distributed insertion portions and holding portions, with the distance of the insertion portions corresponding to the distance of the holding parts.

5. The slat according to claim 3 wherein the holding parts protrude from the holding element laterally and/or in insertion direction.

6. The slat according to claim 3 wherein adjacent holding parts protrude from the holding element to different sides.

7. The slat according to claim 3 wherein the holding parts have an insertion bevel and/or a latching tab.

8. The slat according to claim 3 wherein the insertion portion and the holding portion include a substantially rectangular opening and/or the holding part and/or the holding part has a substantially rectangular cross-section corresponding in particular to the insertion portion.

9. The slat according to claim 2 wherein the width of the insertion portion is larger than or equal to the width of the holding part.

10. The slat according to claim 1 wherein a latching element is provided at the holding element, which can snap into place in the receptacle, in particular in the holding portion.

11. The slat according to claim 1 wherein the base body and/or the add-on part is made of plastic, in particular by injection molding, and the add-on part has a surface coating, in particular a chromium plating.

12. A method for mounting a slat according to claim 1 wherein the holding element is introduced into the insertion portion in an insertion direction and subsequently is shifted in a latching direction substantially vertical thereto, so that the holding element gets into the holding portion.

13. The method according to claim 12 wherein the latching direction substantially extends in longitudinal direction of the base body and/or the add-on part.

14. An injection mold for injection molding a component of a slat according to claim 1, which includes a receptacle, with at least one molded part and at least one slide, wherein the slide is shiftable between an injection position, in which the slide together with the molded part keeps clear the receptacle, and a demolding position, wherein the molded part has the shape of the holding element and at least keeps clear the holding portions, and the slide is formed such that the same keeps clear the insertion regions alone or in combination with the molded part, wherein the slide is movable against the insertion direction, substantially vertically to the longitudinal direction of the component, in particular away from the component, from the injection position into the demolding position.

15. The injection mold according to claim 14 wherein the molded part is formed as second slide and is movable between an injection position, in which the molded part at least keeps clear the holding portions, and a demolding position, in which the molded part engages into the insertion portions.

16. The injection mold according to claim 14 wherein the molded part has a constant cross-section which corresponds to the shape of the holding element and/or the cross-section of the holding part.

17. A method for manufacturing a component for a slat according to claim 1, which includes a receptacle, with an injection mold having at least on molded part and at least one slide comprising the following steps:
the slide is shifted into the injection position in which the slide along with the molded part keeps clear the receptacle,
the injection mold is filled with plastic,
after curing of the plastic, the slide is shifted in a first demolding step into the demolding position in which the insertion portions are cleared,
subsequently, the molded part or the component is shifted in longitudinal direction such that the molded part engages into the insertion portions and the molded part is removed from the receptacle against the insertion direction.
